(19) United States
(12) Patent Application Publication
(10) Pub. No.: US 2011/0215720 A1
(43) Pub. Date: Sep. 8, 2011

(54) Segmented Electron Gun, Beam and Collector System and Method for Electron Cooling of Particle Beams

(76) Inventor: Delbert J. Larson, Waxahachie, TX (US)

(21) Appl. No.: 12/716,411

(22) Filed: Mar. 3, 2010

(51) Int. Cl. H01J 29/51; H01J 27/02; H01J 29/84

(52) U.S. Cl. 315/14; 313/363.1; 313/424

(57) ABSTRACT

A particle beam, segmented electron gun, segmented electron beam and electron collector system and method to achieve low power loss, segmented current control, and segmented energy control in electron beams, including a vacuum chamber to provide a region substantially free of background gas and allow for electron transport, an electron supply device including a segmented cathode to generate the segmented electron beam, an electrode with a grid conducting structure located in front of the segmented cathode and biased with respect to the segmented cathode in order to accelerate electrons away from the segmented cathode and control the current and energy of each electron beam segment, magnetic field production devices such as solenoidal and torroidal wire windings and permanent magnet material to produce magnetic fields to guide the segmented electron beam and to contain neutralizing-background-ions and an electron collector device including electrodes with a grid conducting structure and outer conducting shell structure to contain neutralizing-background-ions within one or more volume regions and one or more collection plates. The collection plates may or may not be water cooled. The segmented cathode is comprised of electron emitting segments separated by non-emitting-regions. By biasing each segment of the segmented cathode appropriately, and by heating each segment of the segmented cathode appropriately, each section of the electron beam can have its current and energy independently controlled. By biasing each segment of the collection system appropriately, efficient recovery of the electron beam can be obtained. Use of the system and method can involve overlapping the segmented electron beam on a particle beam in an overlap region, wherein thermal energy is transferred from the particle beams to the electron beam, which allows an increase in the phase space density and overall density of the particle beams.

### REFERENCES CITED [INCORPORATED IN THEIR ENTIRETY]

### U.S. Patent Documents

U.S. Pat. No. 7,501,640 March 2009 Larson

U.S. Pat. No. 7,368,874 May 2008 Cascone, et al.

U.S. Pat. No. 7,282,711 October 2007 Winkler, et al.

U.S. Pat. No. 7,230,385 June 2007 Sobieradzki, et al.

U.S. Pat. No. 6,838,829 January 2005 Ives

U.S. Pat. No. 6,137,113 October 2000 Muraki

U.S. Pat. No. 5,854,531 December 1999 Young, et al.

U.S. Pat. No. 5,932,972 August 1999 Symons

U.S. Pat. No. 5,550,432 August 1996 Barker

U.S. Pat. No. 5,285,129 February 1994 Takeda, et al.

U.S. Pat. No. 5,138,271 August 1992 Ikegami

U.S. Pat. No. 5,134,343 July 1992 Mathews

U.S. Pat. No. 5,001,438 March 1991 Miyata, et al.

U.S. Pat. No. 4,867,939 September 1989 Deutch

U.S. Pat. No. 4,975,572 December 1990 Rempt

U.S. Pat. No. 4,760,238 July 1988 Sanderson

U.S. Pat. No. 4,694,178 September 1987 Harte

U.S. Pat. No. 4,611,149 September 1986 Nelson

U.S. Pat. No. 4,359,666 November 1982 Tornoe

U.S. Pat. No. 4,096,409 June 1978 Hechtel

U.S. Pat. No. 4,020,381 April 1977 Oess, et al.

U.S. Pat. No. 3,859,552 January 1975 Hechtel

### Other Documents

G. I. Budker, The 1966 Proc. Int. Symp. Electron and Positron Storage Rings, Saclay. Atomnaya Energiya vol. 22 p. 346, 1967.

L. Spitzer, “Physics of Fully Ionized Gases”, (New York: Interscience, 1956) pp. 80-81.

G. I. Budker, et al., Particle Accelerators, Vol. 7, 197-211 (1976).

M. Bell, et al., Physics Letters, Vol. 87B, No. 3, (1979).

T. Ellison, et al., IEEE Trans. Nuc. Sci., Vol. NS-30, No. 4, 2636-2638, (1983).

D. J. Larson, et al., “Operation of a prototype intermediate-energy electron cooler”, NIM, A311, 30-33 (1992).

J. R. Adney, et al., “Progress Report on Construction and Testing of a 3 MeV, DC, Ampere Intensity Electron Beam Recirculation System”, IEEE Trans. Nucl. Sci., Vol. 32, Issue 5 1841-1843 (1985).

### FIELD OF THE INVENTION

The present invention relates to particle beam physics devices, more particularly, to a method and system of increasing the phase space intensity and overall intensity of particle beams by overlapping a properly formed electron beam on a particle beam.

### BACKGROUND OF THE INVENTION

Segmented electron beams have found use in electromagnetic wave generators, cathode ray tubes, materials analysis, and lithography, and the various segments of the electron beam have been made with different energies and beam current densities for these applications. Feedback mechanisms have been used to achieve desired operations for the stated end uses of electromagnetic wave generators, cathode ray tubes, materials analysis, and lithography. The different energies and current densities are achieved by applying different biases on accelerating structures, differential heating of the thermionic cathode segments, or different materials comprising the cathode segments. A segmented cathode has been used in intermediate energy electron cooler development to gradually increase overall current. To date however, segmented electron beams with segmented energy and segmented current density have not been applied to the technology of electron cooling of particle beams.

Depressed collectors for electron beam systems have found use in electromagnetic wave generators. Depressed collectors for electron cooling beams have been constructed that use a solenoidal magnetic field to trap ions transversely and use electric fields to trap ions longitudinally in order to use the trapped ions to neutralize the passing electron beam. This allows for efficient energy recovery of an electron beam. To date however, depressed collectors have not employed gridded conducting structures to contain the needed neutralizing-background-ions, nor have such collectors had separate segments for the collection of a segmented electron cooling beam.

Electron cooling is a technology to the invention proposed herein. Electron cooling was originally proposed by Budker in 1966. The basis for his proposal came from work done by Spitzer (1956) who showed that warm ions come to equilibrium with cooler electrons in a plasma. Due to the much larger mass of the ion, the final rms speed of the ions is much less than that of the electrons. Budker realized that an electron beam is simply a moving electron plasma. By superimposing an ion beam on a co-moving electron beam, warmer ions are cooled by the electron beam.

In the 1970's electron cooling was demonstrated to be an extremely good way of increasing the phase space density and stored lifetime of proton beams. Cooling times of between one and ten seconds were reported by experiments at Novosibirsk, CERN, and Fermilab. An experiment completed in Middleton, Wis. culminated in the construction of an electron cooler capable of cooling intermediate energy (about 5 GeV) antiproton beams.

Uses of high intensity, low energy particle beams may include the production of energy through fusion interactions. Several nuclear reactions are known to produce much more energy than the energy required to initiate the interaction, and the initiation energy is very low by particle beam standards.

Uses of high intensity, low energy particle beams may also include the generation of photons, neutrons and a variety of nuclear isotopes, with improved efficiency and yield. Neutrons, isotopes, or photons are used in numerous applications. Neutron applications include boron neutron capture therapy, neutron radiography, and particularly, neutron irradiation for explosive detection, contraband detection, corrosion detection, and other types of non-destructive analysis. Isotope applications include positron emission tomography (PET). Photon (or gamma ray) applications include photonuclear interrogation which has been proposed as another means of detecting contraband and explosives. Photonuclear interrogation is also used for medical imaging and other nondestructive analysis of a wide range of materials.

Conventional techniques involve an electron supply device including a cathode to supply electrons, and including electrodes biased positively with respect to the cathode and arranged so as to accelerate the electrons so that they have the same velocity as the particles to be cooled. Typically the electron beam is produced with a substantially uniform beam density and a substantially single velocity. This can result in additional power loss in situations where less beam current density is needed in outer beam regions (to cool particle beam halos) and where the electron beam intersects gridded accelerating structures. Additionally, a higher electron beam energy can be desirable in order to mitigate against space charge forces on the extreme outer portion of the electron beam.

Accordingly, there is a need for an improved method and system for using a segmented electron beam for use in particle beam cooling. The segmented electron beam should be provided in a way that allows control over the electron beam current density as well as the electron beam velocity within individual electron beam segments.

Conventional techniques involve an electron collection device including a solenoidal guide field region prior to a collection plate wherein the solenoidal guide field region is biased at a lower potential than electrodes on each of its ends. Typically, the ends of the solenoidal guide field region wherein the beam is passed are substantially open regions free of any material to shape the electric fields, and hence the conventional technique has difficulty in dealing with electron beams of large (many cm diameter) size. Also, typically the collector is not segmented to allow for different collection parameters of different portions of a segmented electron beam.

Accordingly, there is a need for an improved method and system for efficiently collecting large electron beams or segmented electron beams.

### SUMMARY OF THE INVENTION

The present invention, which addresses the above desires and provides various advantages, resides in a method and system for using a segmented electron beam to increase particle beam phase space density in particle beams. The system uses a vacuum chamber to reduce the amount of background gas to a very low level so as not to impede electron beam and particle beam transport. The system includes an electron supply device including a segmented cathode as part of a segmented electron gun to be a source of electrons, an electrode to accelerate the electron beam away from the segmented cathode, an electrode to decelerate the electron beam and to provide longitudinal trapping for space charge neutralizing-background-ions, a magnetic field production device consisting of solenoidal and torroidal wire windings or permanent magnet material to guide the electron beam into and out of the particle beam overlap region, downstream electrodes to accelerate the electrons and to provide longitudinal trapping for space charge neutralizing-background-ions, and an electron collector to collect the electrons after the cooling is completed. The segmented cathode contains electron emitting segments separated from each other by non-emitting-regions. The collector may include one or more neutralized-volumes that contain neutralizing-background-ions, one or more grid conducting structures and one or more outer conducting shell structures biased to ensure that the neutralizing-background-ions are trapped longitudinally within the neutralized-volumes, a solenoidal field to ensure that the neutralizing-background-ions are trapped transversely within the neutralized-volumes, and one or more collection plates biased positively with respect to the nearest neutralized-volume so that secondary emission from the collection plate is suppressed. The collection plate may or may not be water cooled.

The electron velocity of a significant portion of the electron beam is adjusted by an electrode proximate to the overlap region so that the electrons have a predetermined amount of energy to cause the particles in each overlap region to move at an ideal velocity. By traveling and interacting with the particle beam, the electron beam maintains the particle beam within parameters that optimizes end-product production. Any heating, scattering and even deceleration that would otherwise adversely affect the particles in the particle beam is effectively compensated for by the electron beam. Accordingly, scattering and energy loss in the particle beam is substantially continuously compensated for before significant instabilities have an opportunity to develop. In this manner, events that would typically cause significant instabilities in the particle beam are minimized if not eliminated.

The present invention employs a segmented cathode capable of providing a segmented electron beam. By biasing individual segments of the cathode at different potentials, the electron beam velocity can be individually controlled for each segment of the segmented electron beam. The electron current density within each electron beam segment can be controlled by controlling the heating of the individual cathode segments, or by using appropriate cathode materials in the individual cathode segments, or by varying the bias difference between the closest downstream electrode and the cathode segment.

The present invention can be arranged to have a non-emitting portion of the cathode between emitting cathode segments and arranging the downstream accelerating electrode to lie outside the path of electrons emitted by the emitting cathode segments, reducing electron beam power loss in the downstream accelerating and decelerating electrodes.

By using a segmented electron beam to increase the phase space density of particles in particle beams, the overall energy efficiency of the cooling process will be enhanced by the present invention, reducing the operating cost of electron cooled devices. Use of a segmented electron beam to include a higher velocity in the outer segments of the beam will also lead to greater stability for the electron beam.

The present invention employs grids surrounding a neutralizing-volume that allows for high current, low velocity electron beam transport within an electron beam collector. By using the grids, and following the neutralizing-volume by a collection plate, high efficiency recovery of the electron beam energy is possible.

The present invention employs a segmented collection arrangement wherein segments of an electron beam can be collected independently, allowing for high efficiency recovery of the electron beam energy for each segment of the segmented electron beam.

Other features and advantages of the present invention will become apparent from the following detailed description of the preferred embodiments, taken in conjunction with the accompanying drawings, which illustrate by way of example the principles of the invention.

### BRIEF DESCRIPTION OF THE DRAWINGS

The invention is explained in more detail below with reference to the accompanying drawings in which:

FIG. 1 is a schematic view of an electron cooling system for use in the invention;

FIG. 2 is a schematic view of a segmented cathode using substantially square segments;

FIG. 3 is a schematic view of a segmented entrance or exit portion of an electrode using substantially square segments;

FIG. 4 is a schematic view of a segmented cathode using substantially annular segments;

FIG. 5 is a schematic view of a segmented entrance or exit portion of an electrode using substantially annular segments;

FIG. 6 is a schematic view of a segmented cathode using substantially hexagonal segments;

FIG. 7 is a schematic view of a segmented entrance or exit portion of an electrode using substantially hexagonal segments;

FIG. 8 is a schematic view of an entrance or exit portion of an electrode using a circular opening;

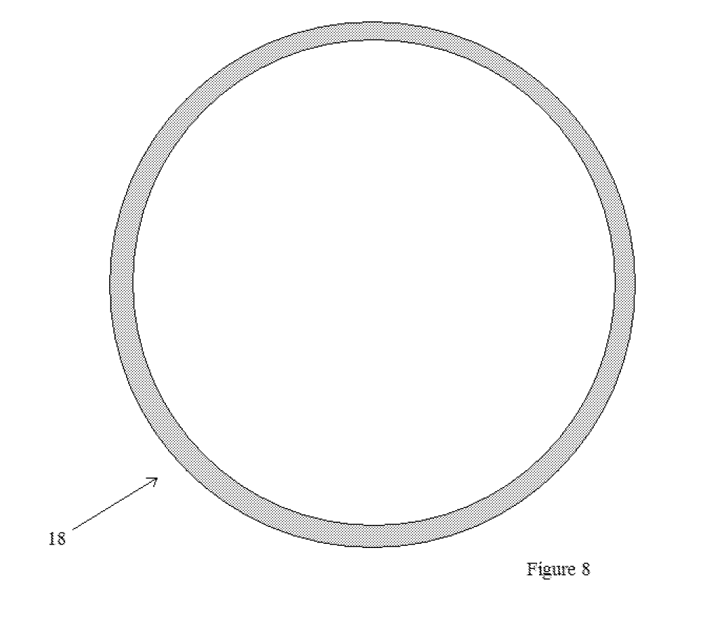

FIG. 9 is a schematic view of a collector employing a low voltage outer shell structure and two low voltage grids and one collection plate for use in the invention;

FIG. 10 is a schematic view of a segmented collector employing two low voltage outer shell structures and four low voltage grids and two collection plates for use in the invention;

FIG. 11 is a schematic view of a segmented entrance or exit portion of an electrode using substantially small square segments within an outer annular region and a substantially open inner circular region;

FIG. 12 is a schematic view of an annular collection plate for use in the invention;

FIG. 13 is a schematic view of a collector employing one low voltage grid and one collection plate for use in the invention;

FIG. 14 is a schematic view of a segmented collector employing two low voltage grids and two collection plates for use in the invention;

FIG. 15 is a schematic end view of a trap volume;

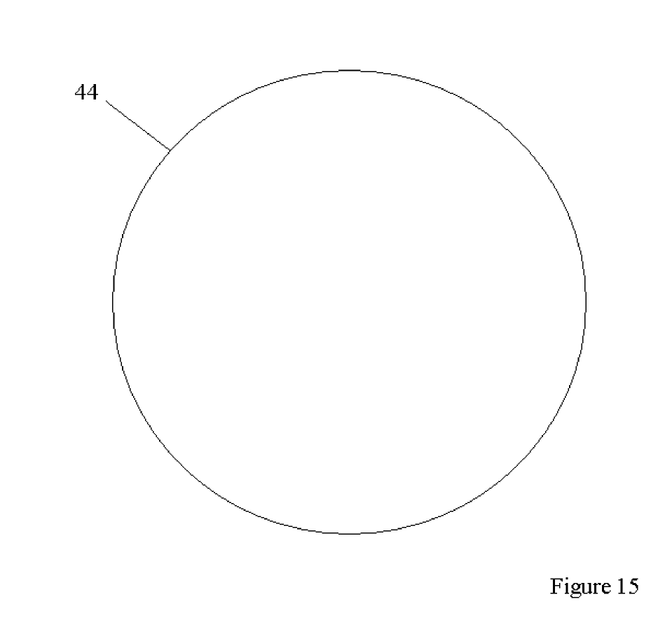

FIG. 16 is a schematic view of an electron cooling system for use in the invention showing a side view of the overlap region;

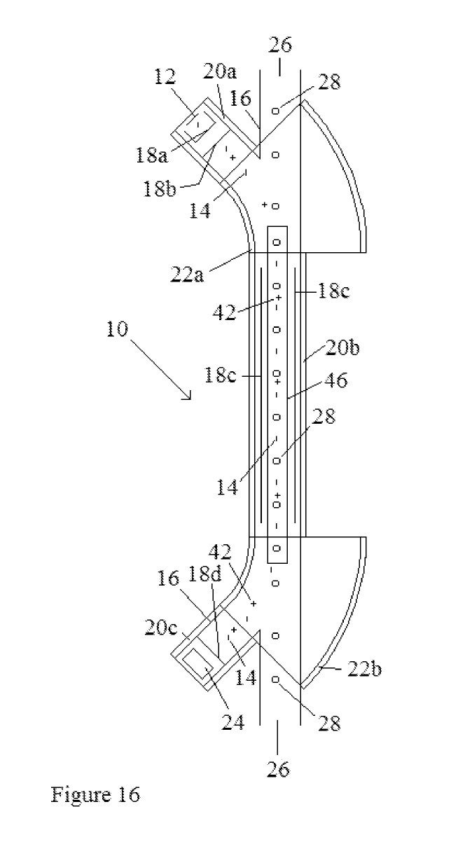

FIG. 17 is a schematic end view of the overlap region;

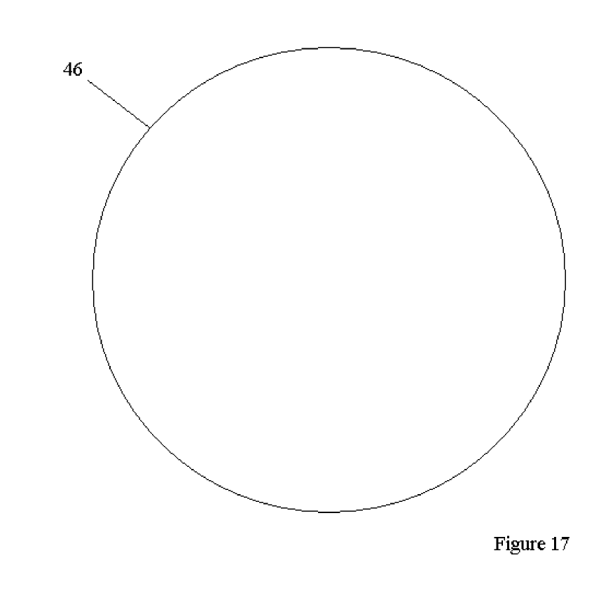

FIG. 18 is a schematic view of a solenoidal magnetic field device and a torroidal magnetic field device comprised of wire windings;

FIG. 19 is a schematic view of a solenoidal magnetic field device and a torroidal magnetic field device comprised of wire windings and permanent magnet material.

### DESCRIPTION OF THE SEGMENTED ELECTRON SOURCE PREFERRED EMBODIMENT

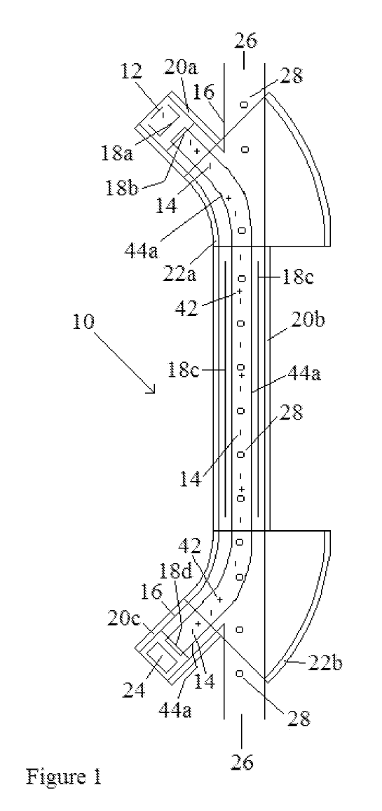

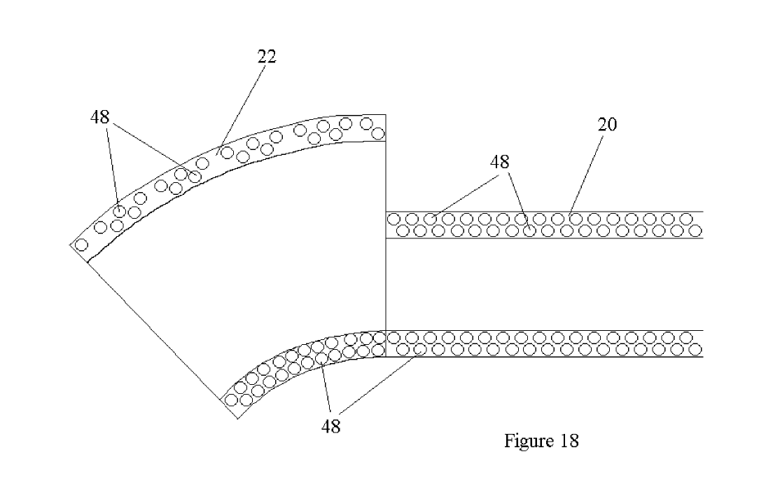

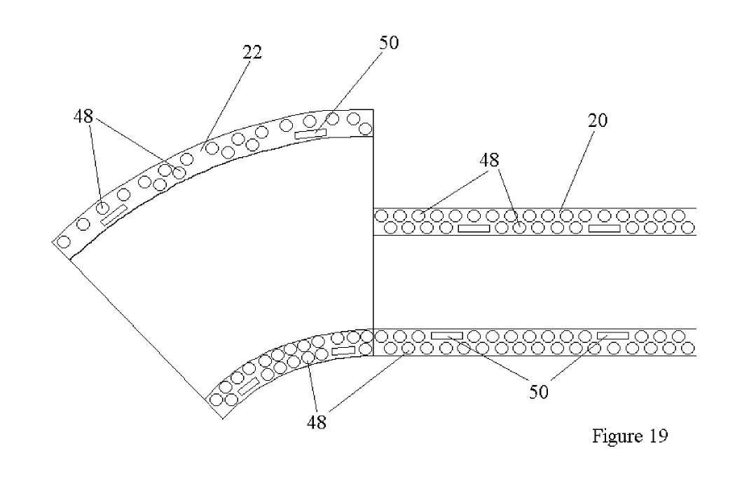

An electron cooling system 10 for increasing the phase space intensity and overall intensity of low energy particle beams is shown in FIG. 1. The electron cooling system 10 utilizes a combination of elements, including an electron supply device which may include a segmented electron gun containing a segmented cathode 12 for supplying a segmented beam of electrons 14, a vacuum chamber 16 for containing particles, electrodes 18 to provide electric fields to accelerate or decelerate the electron 14 beam and which serve to trap neutralizing-background-ions 42, a magnetic field production device including solenoidal magnetic field devices 20 and torroidal magnetic field devices 22 to provide guiding and containing magnetic fields, an electron collector 24 to collect the electrons 14 after they have performed their function, and opposing ports 26 to allow beam particles 28 to enter and leave the electron cooling system 10. FIG. 1 does not show high voltage feedthroughs, water feedthroughs, insulating stands and other such components. FIG. 18 shows solenoidal and torroidal magnetic wire 48 windings; permanent magnet material 50 could also be used to supply the needed magnetic field as shown in FIG. 19.

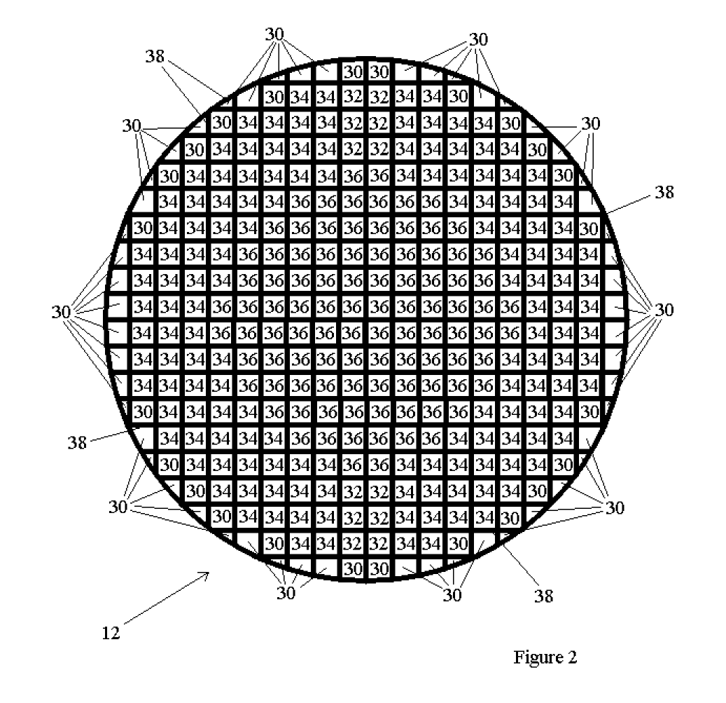

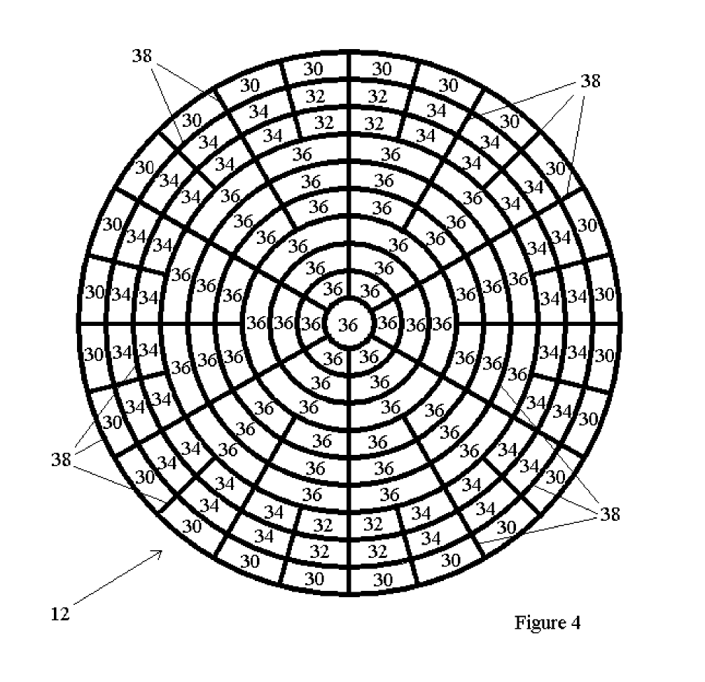

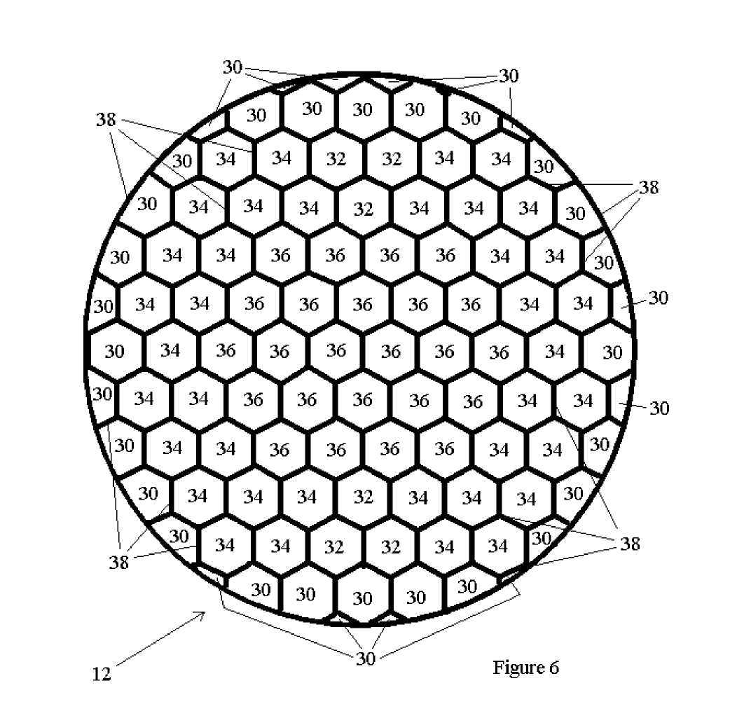

Three different possible segmented cathodes 12 are shown in the figures. FIG. 2 shows a segmented cathode 12 using substantially square or rectangular cathode segments 30, 32, 34, 36; FIG. 4 shows a segmented cathode 12 using substantially annular cathode segments 30, 32, 34, 36, and FIG. 6 shows a segmented cathode 12 using substantially hexagonal cathode segments 30, 32, 34, 36.

The segmented electron cathode 12 includes cathode segments 30, 32, 34, 36 separated by non-emitting-regions 38. Individual cathode segments 30, 32, 34, 36 may be essentially hot surfaces from which electrons 14 are freed. By placing an electrode 18a in front of the individual cathode segments 30, 32, 34, 36 an electric field is generated. The magnitude of the electric field near the individual cathode segments 30, 32, 34, 36 is given by the expression:

E=V/x (1)

In equation (1), V is the potential difference between the individual cathode segments 30, 32, 34, 36 and the electrode 18a and x is the distance between the electrode 18a and the individual cathode segments 30, 32, 34, 36.

With a standard cathode, the amount of electron 14 beam current that is generated by an electron system comprised of an electron cathode and a first electrode 18a is determined by the expression

I=PV^{3/2} (2)

In equation (2), V is the potential difference between the standard cathode and the first electrode 18a and P is a constant, called the perveance, of the particular geometry employed in the system. In many applications, the desired electron 14 matching velocity is low, leading to a low value of voltage, V, which (by equation 2) implies a low value of current, I. Hence, to obtain a high value of current, I, as well as to obtain a longitudinal force to create a trap 44 for neutralizing-background-ions 42, the electrode 18a will typically be biased at a potential greater than that of the downstream electrode 18b. (This is described in U.S. Pat. No. 7,501,640 incorporated by reference.) Electrode 18b is typically set at the potential of the vacuum chamber 16 beam pipe (which is typically ground potential).

In order to achieve electron 14 velocities appropriate for cooling, the electric potential surrounding the cooling region must be set to the appropriate value. The invention allows for a separate potential in an overlap region 46 by supplying a separate electrode 18c proximate to the overlap region 46. By biasing electrode 18c less than electrode 18b multiple scattering effects are reduced in the electron 14 beam. (This is the subject of a separate pending patent.) The electrostatic potential within electrode 18c has some fringe component near the electrode 18c ends, but once the electrons 14 travel deeply into the electrode 18c they will enter a long cooling region of substantially constant electrostatic potential V_{cool} where the electrons 14 will coast along with the particle 28 beam, providing cooling. The velocity of the individual electron 14 beam segments in the long cooling region will be essentially determined by the difference in the potential in that region, V_{cool}, and that of the individual cathode segments 30, 32, 34, 36, V_{cathodeSegment} that emitted the electrons 14.

Desired end uses for the preferred embodiments include the cooling of particle 28 beams stored in a colliding beam dual storage ring system. Such a dual storage ring system can produce energy by way of fusion reactions and be used as a fusion energy power source. Characteristically, the particle 28 beams used in fusion reactions will have an energy of between 20.0 keV and 5.0 MeV and the particles 28 used may be deuterium, tritium, and He-3 or other appropriate materials. As a specific preferred embodiment, the deuterium particle 28 energy can be chosen as 247.2 keV and the tritium particle 28 energy chosen as 167.5 keV. For electron cooling to function, the velocity of the electron 14 beam must be substantially equal to the velocity of the particle 28 beam, and for the case of a 247.2 keV deuterium particle 28 beam this means that the electron 14 beam has an energy of substantially 67.3 eV. For the case of a 167.5 keV tritium particle 28 beam this means that the electron 14 beam has an energy of substantially 30.5 eV. Hence electrode 18c should be biased at substantially 67.3 V with respect to most of the individual cathode segments 30, 32, 34, 36 for cooling of the deuterium particle 28 beam and substantially 30.5 V for the tritium particle 28 beam. Appropriately 500 V of bias of electrode 18b with respect to most of the individual cathode segments 30, 32, 34, 36 will be effective at minimizing multiple scattering.

One goal of any fusion energy device is to get more energy out of the system than is required to run it. Since it is difficult to get a large amount of output energy from fusion reactions, the energy input may be minimized into the dual storage ring system. There are several ways where a segmented electron cooling beam can improve the situation. The invention allows for minimal beam loss to the gridded electrodes 18 in the gun region by placing the grid bars in a position where there is little electron 14 beam current to intercept. The invention allows for separate velocities of electron 14 beam segments by varying the bias independently for each individual cathode segment 30, 32, 34, 36. The invention allows for separate current densities of electron 14 beam segments by varying either or any of the cathode heating, cathode material composition, or cathode extraction electric fields independently for each individual cathode segment 30, 32, 34, 36. Each of these advantages will now be discussed, along with the reason they are each important.

### Electron Source Preferred Embodiment Advantage One—Enabling Minimum Beam Loss to Gridded Gun Electrodes

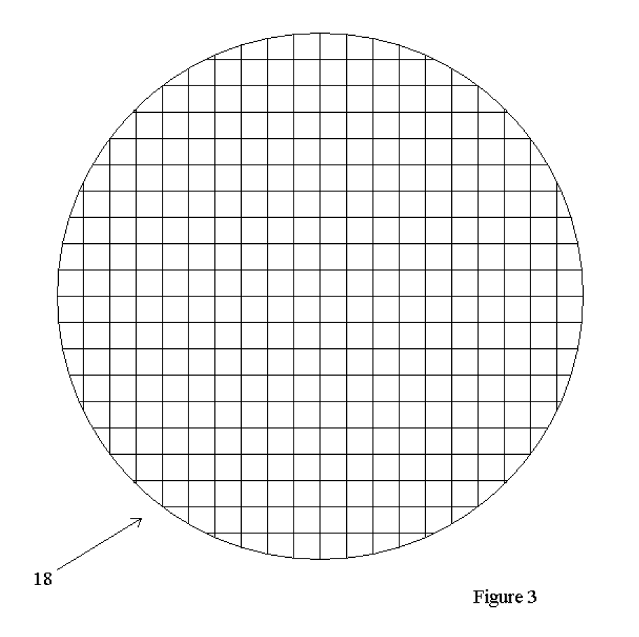

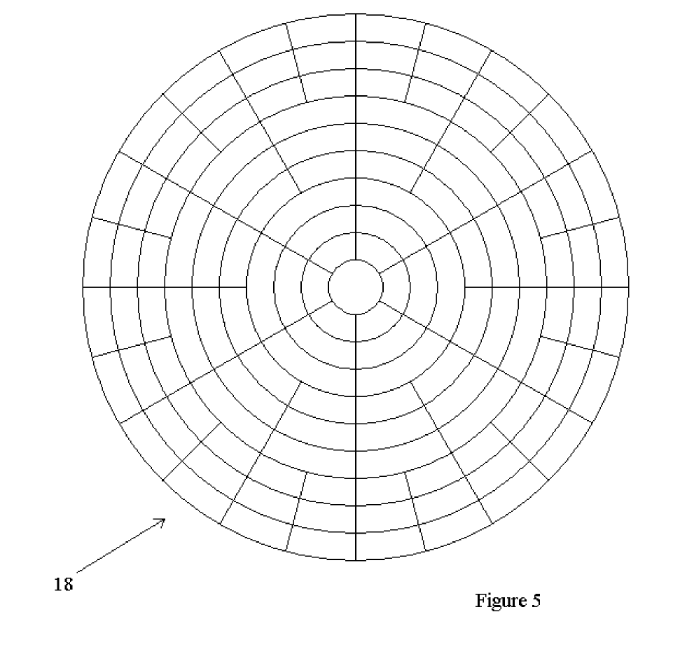

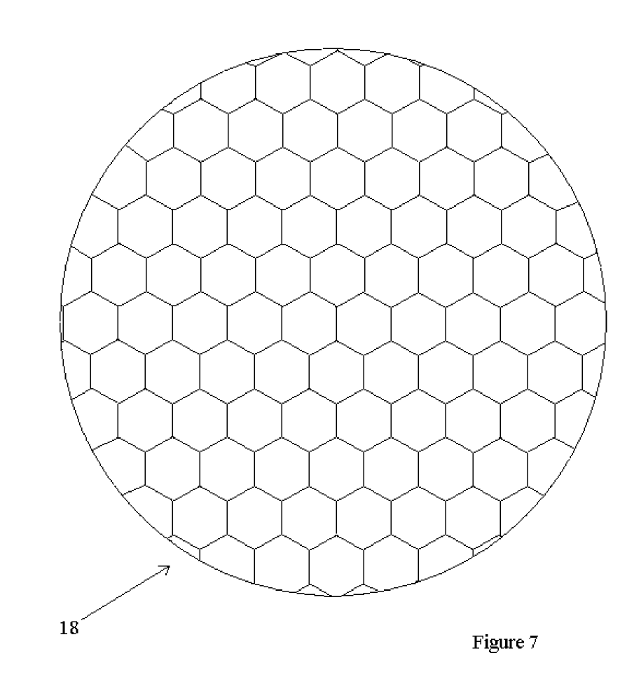

A possible segmented cathode 12 that uses substantially square or rectangular cathode segments 30, 32, 34, 36 is shown in FIG. 2, while a matching segmented electrode 18 using substantially square or rectangular segments is shown in FIG. 3. A possible segmented cathode 12 that uses substantially annular cathode segments 30, 32, 34, 36 is shown in FIG. 4, while a matching segmented electrode 18 using substantially annular segments is shown in FIG. 5. A possible segmented cathode 12 that uses substantially hexagonal cathode segments 30, 32, 34, 36 is shown in FIG. 6, while a opposing segmented electrode 18 using substantially hexagonal segments is shown in FIG. 7. In each case, the emitting cathode segments 30, 32, 34, 36 of the segmented cathode 12 may be smaller than the hole spaces of the electrode 18, and each of the emitting cathode segments 30, 32, 34, 36 may be surrounded by a non-emitting-region 38. This allows each segment of the segmented electron 14 beam to pass through holes of the electrode 18 without any or with little of the beam being lost due to hitting the bars of the electrode 18 which in turn results in less power loss from the electron 14 beam, and it will also help to ensure grid survivability. (The invention could also employ irregularly shaped segments, or it could employ a mixed set of the hexagonal, square, annular or irregularly shaped segments. FIGS. 2-7 simply present some example structures that could be used in the invention.)

There is more than one option to achieve the required electron 14 density in the cooling region. One could accelerate a lower density beam at the cathode 12 and then increase the density by increasing the immersing solenoidal magnetic field. (Or one could use a higher density beam at the cathode 12 and reduce the immersing soleoidal magnetic field.) The choice here is to investigate a case where the solenoid immersing the gun has substantially the same magnetic field as that in the main cooling region.

In order to estimate the accelerating field requirement for a fusion electron gun, note that a conventional electron gun is capable of producing approximately 4 A of electron current from a 1 cm radius cathode by immersing it in a 1 kV/mm electric field. Such a conventional gun is therefore capable of producing 1.27 A/cm² under a 1 kV/mm electric field. A fusion system will use electron 14 currents in the range of 10,000 amperes within a 30 cm radius beam. In order to reach the desired current density of 3.54 A/cm² it will be necessary to increase the electric field. Using Eq. (2) above, I=PV^{3/2}, it can be determined that the electric field necessary to achieve the required electron 14 density is V=(3.54/1.27)^{2/3} kV/mm=1.98 kV/mm.

Since the electron cooling beam is designed herein to operate with a potential on the order of tens of Volts, the electrons 14 may be accelerated from the cathode using an electrode 18a several millimeters away from the cathode 12 surface at several to tens of kV potential, and then decelerate the electrons 14 to provide a reversed electric field. The reversed field will trap neutralizing-background-ions 42 in the cooling region and allow for the current to vastly surpass the limits that self space charge would otherwise present, as described in U.S. Pat. No. 7,501,640 incorporated by reference in its entirety. In a specific example depicted in FIG. 1, the first electrode 18a can be placed 4 mm from the cathode 12 at a potential of about 8 kV with respect to cathode 12, with the second electrode 18b a further 3.5 mm downstream at a potential of 500 V with respect to cathode 12, and the electrons 14 will achieve their cooling beam potential by an electrode 18c proximate to the cooling section.

An estimate of the allowable electrode 18b hole size starts with the charge per unit meter within the hole. For an electron 14 beam λ=I/v, where λ is the charge per unit meter, I is the electron 14 beam current and v is the velocity of the electrons 14. For the case of the 500 V electrode 18b, v=1.33×10⁷ m/s, and with I=10,000 A this leaves λ=7.54×10⁻⁴ C/m, and, with a beam radius of r=30 cm, this leaves a charge per unit volume of ρ=λ/πr²=2.67×10⁻³ C/m³. If the spacing of the wires is 4 mm, a good estimate of the self space charge depression is given by use of Gauss's Law ∫ε₀E(dA)=qᵢₙ. (Here, ε₀=8.85×10⁻¹² C²/Nm², E is the electric field, dA is the differential area and qᵢₙ is the charge within the volume surrounded by the area of integration.) Within a sphere of charge of radius r this becomes ε₀E4πr²=(4/3)πr³ρ, or, E=(ρ/3ε₀)r, and the self potential is V=∫Edr=(ρ/6ε₀)r². With r=2 mm this leaves a self potential of

V=(2.67×10⁻³ C/m³)(2×10⁻³ m)²/6(8.85×10⁻¹² C²/Nm²)=201 V. (3)

Equation 3 is a reasonable upper limit of an acceptable voltage depression, since the electron 14 energy here is 500 V. However, the electron 14 beam will be substantially neutralized by trapped neutralizing-background-ions 42 on one side of the grid. This neutralization will allow a larger hole size, and therefore hole sizes in the range of a few millimeters to a few centimeters are appropriate.

A first consideration of an estimate of the size of the non-emitting-regions 38 that separate the cathode segments 30, 32, 34, 36 comes from the self space charge forces of the electron 14 beam. Here an estimate of the density of the beam will be ρ=1×10⁻³ C/m³. (This is lower than what is calculated for the 500 eV beam above due to the higher average velocity during the beam transit from low voltage to 8 keV.) Using the spherical approximation for the space charge calculated above, E=(ρ/3ε₀)r and for a 2 mm sphere of charge this becomes

E=(1×10⁻³ C/m³)(2×10⁻³ m)/3(8.85×10⁻¹² C²/Nm²)=75.3 V/mm. (4)

However, this estimate is from the space charge of one of the cathode segments 30, 32, 34, 36, and the effect from the adjacent cathode segment 30, 32, 34, 36 will be significant and largely cancel out the field, leaving less than 10% of the calculated field:

E<7.53 V/mm. (5)

The electric field estimated by Eq. (5) is 0.38% of the main accelerating field. Hence a rough estimate on how far the edge of the beam will expand transversely is 0.38% of the longitudinal distance traveled, or 28.5 microns.

A second consideration of an estimate of the size of the non-emitting-regions 38 that separate the cathode segments 30, 32, 34, 36 comes from the thermal velocities of the emitted electrons 14. For this effect, consider an electron 14 that leaves the cathode surface perpendicularly with an energy of 0.1 eV. This electron 14 will have vₓ=1.876×10⁵ m/s. The acceleration will be in the beam direction, with a=eE/m=(1.6×10⁻¹⁹ C)(2×10⁶ V/m)/(9.1×10⁻³¹ kg)=3.52×10¹⁷ m/s². The time it takes the electron 14 to go from the cathode to electrode 18a can be deduced from the formula d=½at². With d=4 mm, t=1.51×10⁻¹⁰ s. During this time, the electron 14 will travel a transverse distance of x=(1.876×10⁵ m/s)(1.51×10⁻¹⁰ s)=28 microns. Since the electron 14 will then be decelerated to approximately 500 eV, the total increase in horizontal size will be two times the 28 microns, or about 56 microns.

A third consideration of an estimate of the size of the non-emitting-regions 38 that separate the cathode segments 30, 32, 34, 36 comes from the magnetic force of the guiding magnetic field. Electron 14 transport will be accomplished by having the electrons 14 immersed in guide fields produced by solenoidal magnetic field devices 20 and torroidal magnetic field devices 22. The electrons 14 will leave the cathode 12 in this field, and execute helical motions around the guiding magnetic field lines. The orbital radius of these gyrations is determined from the Lorentz force equation, evB=mv²/r, or,

r=mv/eB. (6)

Note that the velocity of Eq. (6) is the velocity perpendicular to the magnetic field lines, which is determined from the temperature of the cathode 12, which is typically about 0.1 eV. With ½mv²=0.1 eV, vₚₑᵣₚ=1.88×10⁵ m/s. The electrons 14 will tightly spiral around the field lines. For either the deuterium particle 28 or tritium particle 28 case, assuming a solenoidal or torroidal guide field of 100 Gauss, the gyro radius given by Eq. (6) is:

r_{gyro}=0.107 mm. (7)

Of course, the gyro-radius given in Eq. (7) will only be achieved if the magnetic force exceeds the electric force. For the applied 100 G field, the magnetic force is vB=0.01 T×1.88×10⁵ m/s=1.88×10³ V/m, which is about one quarter of the electric field calculated in Eq. (5). The magnetic field will therefore reduce, but not contain, the effect of the electric field.

Summing the approximate effects of the electric field, the magnetic field, and the thermal expansion estimated above, the non-emitting-region 38 surrounding the cathode segments 30, 32, 34, 36 should be approximately 200 microns in size (100 microns for each adjacent emitting region).

Grids may have a wire thicknesses of substantially 12 microns. The discussion above indicates that the hole size of the electrode 18a and electrode 18b should be about 4 mm wide. Hence, the electron gun could be designed to have cathode segments 30, 32, 34, 36 about 3.9 mm wide, surrounded by approximately 200 micron regions of non-emitting material. The first electrode 18a could be placed about 4 mm downstream from the cathode 12 emission surface and placed at a potential of about 8 kV. The second electrode 18b could be placed 3.5 mm further downstream at a potential of about 500 V. The solenoidal magnetic field devices 20 and torroidal magnetic field devices 22 should generate a guide field that matches the solenoidal magnetic field used in the main electron cooling sections (100 Gauss), and this field may immerse the electrons 14 throughout their entire trajectory, beginning at the gun. Such a device will achieve the significant advantages of very low electron 14 power loss on the electrode 18a and the electrode 18b, resulting in low power loss and long electrode 18 life.

### Electron Source Preferred Embodiment Advantage Two—Enabling a High Intensity Electron Beam for Core Particle Beam Cooling Only Where Needed

Colliding beam fusion devices must obtain very high efficiency in order to achieve more output power than the input power required to operate the devices. The electron 14 beam may be shaped to match the core particle 28 beam. The invention allows this by using cathode segments 36 that together are shaped to be a good match to the downstream optics of the central core of the particle 28 beams that will be collided for fusion purposes.

This advantage of the invention may allow increased efficiency of electron cooled colliding beam fusion devices by employing near maximum electron 14 currents where needed, and lower currents where lower currents are needed.

### Electron Source Preferred Embodiment Advantage Three—Enabling a High Velocity Outer Shell in the Electron Beam to Guard Against Space Charge Instability

For very low energy electron 14 beams, such as those needed for the cooling of colliding beam fusion devices, extremely high levels of space charge neutralization are needed. Should the neutralization not be sufficiently complete, the excess negative charge will manifest itself on the outside of the beam. (Charge always flows to the outside of a conductor.) In this case, the flow will be caused by neutralizing-background-ions 42 flowing to the center to neutralize the center of the beam. This will leave a condition where the outside portion of the beam is not neutralized. If the potential energy associated with the self space charge of the non-neutralized portion exceeds the electron 14 beam energy, the electron 14 beam will no longer flow and will become unstable. This condition would eventually destroy the entire electron 14 beam.

The present invention allows for a mitigation of this effect, so that even in cases of incomplete space charge neutralization the electron cooling can function. The advantageous effect is arranged by biasing the outermost cathode segments 30 at a more negative potential than the cathode segments 32, 34, 36. With a uniform potential on the electrodes 18a, 18b and 18c, the more negative biasing of cathode segments 30 will result in the outer segment of the electron 14 beam having more energy than the central portion of the beam. If the neutralizing positive charge is incomplete, the outer portion of the beam will not be neutralized, but since it has a higher energy it is much better prepared to survive non-neutralized transport.

Specific parameters are best determined empirically, but it is foreseen that an additional bias of a few hundred to a few thousand volts may be sufficient to produce the desired advantageous effect.

This advantage of the invention will allow stable beam transport of low energy beams even in the presence of incomplete neutralization.

### Electron Source Preferred Embodiment Advantage Four—Enabling a Low Current Density for Large Angle Scattering Produced Halo

In a colliding beam fusion energy device many of the particle 28 collisions will not result in fusion events; instead they may result in large angle scattering events. It is important not to lose the energy of those scattered particles 28 so that the device still produces more energy than is required to operate it. After scattering, the particles 28 will be focused by the same magnets as the main beam, but will have a larger radial offset than the main beam once they reach the cooling section. Hence, the electron 14 beam must be larger radially than what is required simply to cool the main particle 28 beam. But the large radius particles 28 do not need much electron 14 current to cool them, and so using the full beam current density in these regions may be wasteful. Therefore the invention uses cathode segments 34 that either have a material composition that limits the current density or are heated less to result in less current density than the main beam.

This advantage of the invention may allow maximum energy recovery of the large angle scattered particles 28 while minimizing the electron 14 current and associated electron 14 beam power input necessary to do so.

### Electron Source Preferred Embodiment Advantage Five—Enabling a High Current Density for Injected Particle Trajectories; Enabling Electron Cooled Stacking Injection

Particle 28 beam injection into a colliding beam fusion energy system can be accomplished by injecting the particles 28 at a small angle into the electron 14 beam so that the electron cooling mechanism can deflect the particles 28 onto a recirculating path. In this case, the electron 14 beam should have a high density of electrons 14 throughout the region where the particles 28 are. Typically, the electron 14 density may be higher than that provided by cathode segments 34, and the cathode segments 32 are used for this purpose. Note that the current density from cathode segments 32 will typically be substantially the same as the current density from cathode segments 36. (Cathode segments 36 are used to provide electron cooling of the particle 28 beam core.)

This advantage of the invention will allow near maximum electron cooling of injected particles 28 while confining the region of near maximum electron 14 density to just that region needed for that purpose. This will increase the overall efficiency of colliding beam fusion devices.

### Electron Source Preferred Embodiment Advantage Six—Enabling a High Current Density for Space Charge Produced Beam Halo

In addition to the beam halo produced by large angle single scattering events discussed in preferred embodiment advantage four, a second source of beam halo arises from space charge forces. This latter effect causes particles 28 to arrive at the cooling straight with a large angle, and hence a large cooling density of electrons 14 is needed. Advantageously, this halo can be arranged to lie in the same plane as the injected particle 28 beam, and so this halo can be effectively cooled by electrons 14 sourced from cathode segments 32. While the injected beam will typically come in from just one side of the electron 14 beam, the halo will typically exist on both sides, and that is why cathode segments 32 are shown on each side of FIG. 2, FIG. 4, and FIG. 6. Typically, the electron 14 density must be higher than that provided by cathode segments 34, and the cathode segments 32 are used for this purpose. Note that the current density from cathode segments 32 will typically be substantially the same as the current density from cathode segments 36.

This advantage of the invention will allow for near maximum electron 14 density exactly where it is needed in order to cool space-charge-produced particle 28 halo while confining the region of maximum electron 14 density to just that region needed for that purpose. This will increase the overall efficiency of colliding beam fusion devices.

### Electron Source Preferred Embodiment Advantage Seven—Enabling Empirical Determination of Best Operating Conditions

While FIG. 2, FIG. 4, and FIG. 6 each show an example of some specific configurations for cathode segments 30, 32, 34 and 36, these are of course just examples. An important advantage of the invention is that the electron 14 density and electron 14 energy can be determined empirically, by varying either the segment heating or the segment bias voltage, in order to determine the optimum device operating conditions.

This advantage of the invention will allow for empirical determination of the appropriate electron 14 density in each region in order to effectively cool particle 28 beams. This will allow for an optimization of the overall efficiency of colliding beam fusion devices.

### DESCRIPTION OF THE ELECTRON BEAM COLLECTOR PREFERRED EMBODIMENTS

### A First Electron Beam Collector Preferred Embodiment—A Collector Employing a Low Voltage Shell and Two Low Voltage Grids and One Collection Plate

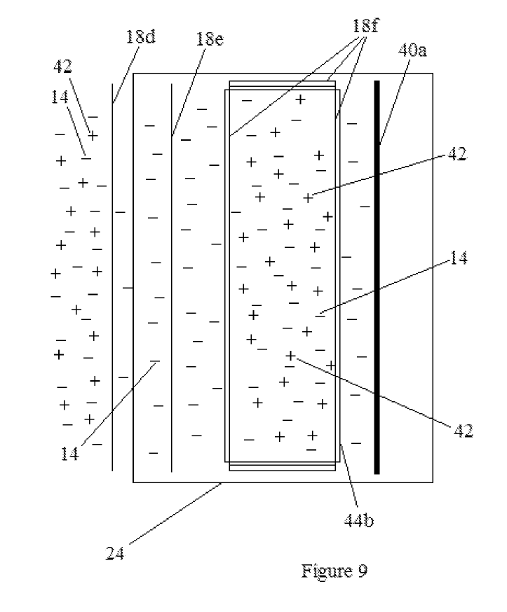

A first preferred electron beam collector 24 embodiment is shown in FIG. 9. In this embodiment, the electron 14 beam passes through electrode 18d (electrode 18d is also shown in FIG. 1) and then the electron 14 beam is accelerated and passes through electrode 18e. Next, the electron 14 beam is decelerated and passes through electrode 18f just before the electron 14 beam is accelerated into a collection plate 40a. The collection plate 40a may be water cooled. Electrode 18f is comprised of outer conducting shell structure with a grid conducting structure on its upstream end and an optional grid conducting structure on the downstream end. Electrodes 18d and 18e, and the grids on the ends of electrode 18f can be constructed with either substantially square or rectangular segments as shown in FIG. 3, substantially annular segments as shown in FIG. 5, substantially hexagonal segments as shown in FIG. 7, or a combination of those, or any substantially open segments. Voltage feedthroughs, water cooling feedthroughs, support structures and other equipment are not shown in the figures for any of the electron beam collector 24 preferred embodiments. As long as longitudinal fields are arranged to form a trap 44 for neutralizing-background-ions 42 longitudinally and a solenoidal field is arranged to form the trap 44 for the neutralizing-background-ions 42 transversely, the neutralizing-background-ions 42 will be trapped within electrode 18f, neutralizing the electron 14 beam's self space charge within electrode 18f. By biasing the collection plate 40a positively with respect to electrode 18f, the electrons 14 will be accelerated into the collection plate 40a and any secondary electrons emitted will be returned to the collection plate 40a by the electric accelerating field near the collection plate 40a. One quantity of interest is to calculate the size of the hole within the grids that is needed to overcome the electron 14 beam's self space charge so that the electron 14 beam does not become unstable in the neutralizing-background-ion-free regions.

The potential of the electron 14 beam in the region between the downstream grid of electrode 18f and the collection plate 40a due to its own self space charge can be calculated assuming that the un-neutralized electrons 14 from the beam form a thin slab of charge. A further assumption is that the neutralizing-background-ions 42 will at some point be turned back into electrode 18f, due to the electric field created by the potential difference between the collection plate 40a and electrode 18f.

Approximately, the thickness of the slab of charge may be estimated by assuming that the neutralizing-background-ions 42 are contained within the electrode 18f. Under that assumption, the longitudinal slab thickness may be the distance between electrode 18f and the collection plate 40a, which can be specified for example as 400 microns. Transversely, the electron 14 slab is equal to the size of the electron 14 beam, which for example might be a 40 cm radius circle. Since the transverse dimensions are so much greater than the longitudinal dimension, a Gaussian pillbox with height 2x and cross sectional area A can be used to determine the electric field within the slab and applying Gauss' Law:

∫ε₀E(dA)=qᵢₙ. (8)

For the case of a 30 V electrode 18f, v=3.25×10⁶ m/s, and with I=10,000 A this leaves λ=I/v=3.08×10⁻³ C/m, and, with a beam radius of r=30 cm, this leaves a charge per unit volume of ρ=λ/πr²=1.09×10⁻² C/m³. Within the pillbox of charge Eq. (8) becomes ε₀E2A=A2xρ, or, E=(ρ/ε₀)x, and the self potential is V=∫Edr=(ρ/2ε₀)x². With ε₀=8.85×10⁻¹² C²/Nm², and x=0.2 mm this leaves a self potential of

V=(0.0109 C/m³)(2×10⁻⁴ m)²/2(8.85×10⁻¹² C²/Nm²)=24.6 V. (9)

In Eq. (9) the potential is calculated between the center of the mid-plane of the slab of charge and either of its end-planes. (By symmetry, the self-potential of one end-plane is the same as the other.) A first problem immediately evident with our assumption is that the 24.6 V potential will slow down the electrons 14, increasing their density, and further increasing the potential difference between the mid-plane of the slab and the end-planes. But a second problem is the assumption that the neutralizing-background-ions 42 will turn around at the grid plane.

Considering a case where the collection plate 40a is biased at 5 V with respect to the electrode 18f exit grid, it is seen that the electric field created by the grid to collector bias is 5V/400 microns=12.5 kV/m, while the electric field created by the electron 14 beam self space charge is E=(ρ/ε₀)x=(0.0109 C/m³)(2×10⁻⁴ m)/(8.85×10⁻¹² C²/Nm²)=246 kV/m. Hence, were the neutralizing-background-ions 42 to stop at the grid plane, the potential of the slab of electrons 14 would create a force to accelerate the neutralizing-background-ions 42 out of the cylinder and past the grid plane. What may happen of course is that the neutralizing-background-ions 42 won't be reflected at the grid plane, rather, they will be reflected at that point where the electric field reflects them. This will cause the slab of electron 14 charge to be thinner than the previous assumption, as the neutralizing-background-ions 42 will extend past the grid plane up to the point where the electric field forces them back. The potential of the neutralized region will remain the potential of electrode 18f (the neutralized region contains a conducting plasma) and hence the bias of the collection plate 40a will create a field that is E₁=5V/t, where t is the distance between the collection plate 40a and the plane where the electric field becomes non-zero. And once the electric field is non-zero, the neutralizing-background-ions 42 will be expelled and the electric field caused by the now non-neutralized electrons 14 will be E₂=(ρ/ε₀)t/2. By setting E₁=E₂, the thickness of the slab can be solved for: 5V/t=(ρt/2ε₀), or t²=2ε₀5V/ρ, leaving t=(2ε₀5V/ρ)^{1/2}=(2×8.85×10⁻¹²[C²/Nm²]5[Nm/C]/0.0109 [C/m³])^{1/2}=90 microns.

The above calculation indicates that instead of the electron 14 density being un-neutralized for the full 400 micron separation distance of the assumption, it is instead neutralized for 310 microns and only in the last 90 microns are the space charge forces felt. This in turn has ramifications on the required hole size of the downstream grid of electrode 18f. What is important is not that the grid holes themselves be so small and so closely spaced to the collection plate 40a so that the self electric field is contained. Rather, what is important is that the grid establish a potential within the neutralizing-background-ion 42 and electron 14 space charge clouds that then remains up to the point where the electrons 14 are accelerated into the collection plate 40a further downstream. Hence, the grid hole size can be considerably larger than what would be the case were there no neutralizing-background-ions 42. While the optimum hole size is best determined empirically, a hole size of a few millimeters to several centimeters should be sufficient to set up the desired collection fields. In some cases the downstream end of the hollow cylinder will not need any grid at all, as discussed below in an optional preferred embodiment of the collector. Also the beam energy within electrode 18f can be lower than used here, and biases of electrode 18f can be in the range of a few to a few tens of volts, allowing for maximum energy recovery of the electron 14 beam.

On the upstream side of electrode 18f an electrode 18e with a high potential will be used. The potential difference between electrode 18e and electrode 18f will create a longitudinal electric field that will return the neutralizing-background-ions 42 back into electrode 18f. In addition, the potential difference between electrode 18e and electrode 18d will also set up a longitudinal electric field to return neutralizing-background-ions 42 back into the cooler region. For fusion power applications where the cooling electron 14 beam has an energy of 30 eV to 80 eV, a level for the potential of electrode 18e may be about 4000 V with respect to cathode 12. With a voltage difference between electrode 18e and electrode 18f of close to 4000 V, and with a 4 mm longitudinal separation of electrode 18e from the upstream grid of electrode 18f, the electric field will be about 1000 kV/m. In this case the thickness of the slab of electron 14 charge is 4 mm, ten times greater than the slab considered above, but the density of the electrons 14 within the slab are inversely proportional to the electron 14 velocity. The electron 14 density near electrode 18e in this example is over ten times less than the density near electrode 18f. Hence, the applied electric field will be greater than the field of the electron 14 charge and neutralizing-background-ions 42 will be confined to within electrode 18f on the upstream side. As with the case of the downstream grid of electrode 18f, the hole size of the upstream grid of electrode 18f can be set to a value larger than what would be needed were there no neutralizing-background-ions 42. The presence of the neutralizing-background-ions 42 means that the purpose of the grid is to establish a potential for the neutralizing-background-ion 42 and electron 14 plasma, and hence the hole size can again be in the range of a millimeter to a few centimeters as can be determined empirically for the specific application desired.

The size of the holes in the electrode 18e can be determined by the self space charge potential of the electrons 14 within it. (Since electrode 18e is positive with respect to neighboring electrodes 18 neutralizing-background-ions 42 will be repelled from electrode 18e and there will be no neutralization within its holes.) For the case of the 4 kV electrode 18e, v=3.75×10⁷ m/s, and with I=10,000 A this leaves λ=I/v=2.67×10⁻⁴ C/m, and, with a beam radius of r=30 cm, this leaves a charge per unit volume of ρ=λ/πr²=9.43×10⁻⁴ C/m³. If the spacing of the wires is 1 cm, a good estimate of the self space charge depression is given by use of Gauss's Law ∫ε₀E(dA)=qᵢₙ. (Here, ε₀=8.85×10⁻¹² C²/Nm², E is the electric field, dA is the differential area and qᵢₙ is the charge within the volume surrounded by the area of integration.) Within a sphere of charge of radius r this becomes ε₀E4πr²=(4/3)πr³ρ, or, E=(ρ/3ε₀)r, and the self potential is V=∫Edr=(ρ/6ε₀)r². With r=5 mm this leaves a self potential of

V=(9.43×10⁻⁴ C/m³)(5×10⁻³ m)²/6(8.85×10⁻¹² C²/Nm²)=444 V. (10)

Equation 10 is an acceptable voltage depression, since the electron 14 energy here is 4 kV.

The advantage of the invention will allow for a high efficiency collection of an electron 14 beam. This will allow for a near optimization of the overall efficiency of colliding beam fusion devices.

### A Second Electron Beam Collector Preferred Embodiment—A Segmented Collector Employing Two Low Voltage Shells and Four Low Voltage Grids and Two Collection Plates

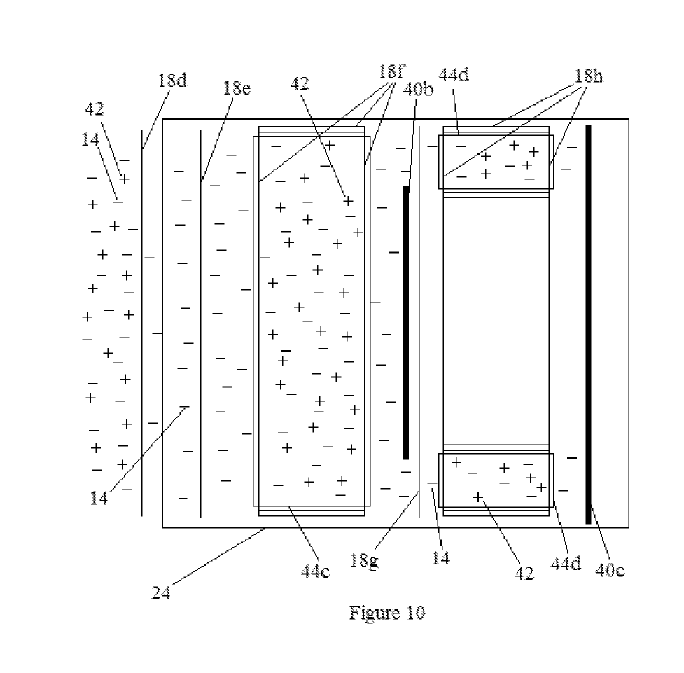

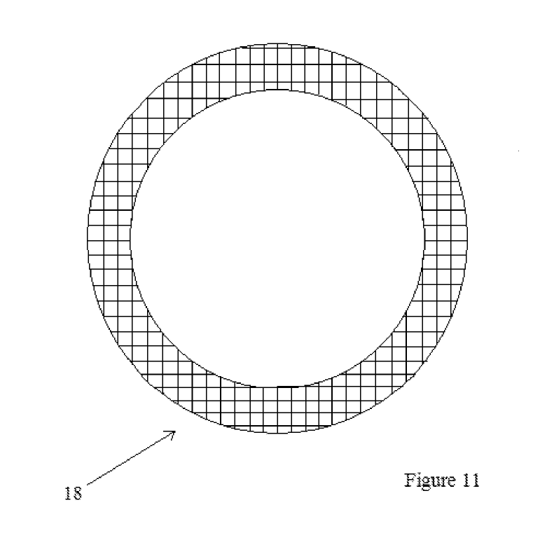

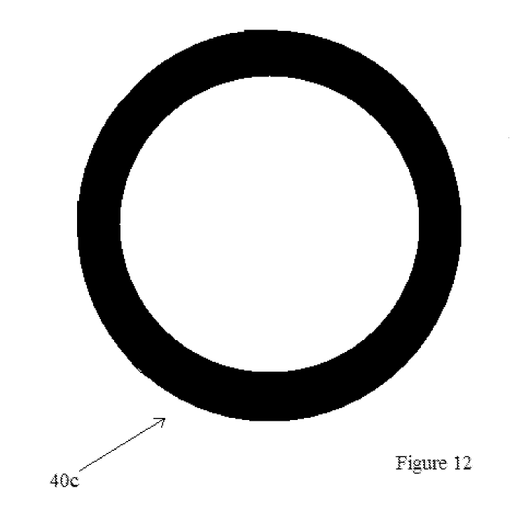

A second preferred electron beam collector 24 embodiment is shown in FIG. 10. In this embodiment, the electron 14 beam passes through electrode 18d (electrode 18d is also shown in FIG. 1) and then the electron 14 beam is accelerated and passes through electrode 18e. Next, the electron 14 beam is decelerated and passes through electrode 18f just before the central portion of the electron 14 beam is accelerated into a collection plate 40b. The outer portion of the electron 14 beam is accelerated by electrode 18g, then decelerated by electrode 18h and finally accelerated into a collection plate 40c. The collection plates 40 may be water cooled. Electrodes 18f and 18h are comprised of an outer conducting shell structure with a grid conducting structure on their upstream end and an optional grid conducting structure on their downstream end. Electrodes 18d, 18e, 18g and the grids on the ends of electrodes 18f and 18h can be constructed with either substantially square segments as shown in FIG. 3, substantially annular segments as shown in FIG. 5, substantially hexagonal segments as shown in FIG. 7, or a combination of those, or any substantially open segments. Electrode 18g and the grids on the ends of electrode 18h could optionally be constructed as shown in FIG. 11, which shows substantially square or rectangular segments in an outer annular region as an example, but any substantially open segments on the outer annular region should perform well. The collection plate 40b can be constructed as a disk, and the collection plate 40c can be constructed either as a disk or as an annular structure as shown in FIG. 12.

The operation of the second preferred embodiment is largely identical to the operation of the first preferred embodiment, except that the outer portion of the electron 14 beam passes by the first collection plate 40b. For an electron cooled colliding beam fusion application, the outer portion of the electron 14 beam could have a higher energy than the central portion of the beam. In order to recover the energy, electrode 18h is biased more negatively than 18f, and the collection plate 40c is biased more negatively than the collection plate 40b. Since the operation is similar, the hole sizes for electrodes 18d, 18e and 18f are the same as what was calculated in the description of the first preferred embodiment, while the hole sizes of electrode 18g will be in the range of a few mm to a few cm, and the hole sizes of electrode 18h will be similar to that of electrode 18f. The bias of electrodes 18f and 18h can be a few to a few tens of volts with respect to their corresponding cathode segments 30, 32, 34, 36.

The advantage of the invention will allow for high efficiency collection of an electron 14 beam that has different energy in different segments. This will allow for a near optimization of the overall efficiency of colliding beam fusion devices.

### A Third Electron Beam Collector Preferred Embodiment—A Collector Employing One Low Voltage Grid and One Collection Plate

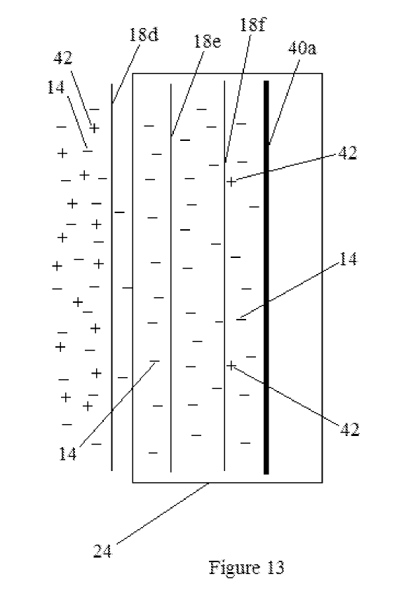

A third preferred electron beam collector 24 embodiment is shown in FIG. 13. In this embodiment, the electron 14 beam passes through electrode 18d (electrode 18d is also shown in FIG. 1) and then the electron 14 beam is accelerated and passes through electrode 18e. Next, the electron 14 beam is decelerated and passes through electrode 18f just before the electron 14 beam is accelerated into a collection plate 40a. The collection plate 40a may be water cooled. In this embodiment, electrode 18f may be comprised of a single grid. Electrodes 18d, 18e and 18f can be constructed with either substantially square or rectangular segments as shown in FIG. 3, substantially annular segments as shown in FIG. 5, substantially hexagonal segments as shown in FIG. 7, or a combination of those, or any substantially open segments.

Operation of the third preferred embodiment is similar to the operation of the first preferred electron beam collector embodiment in that electrode 18e provides longitudinal trapping of neutralizing-background-ions 42 upstream of electrode 18d, electrode 18f slows the electrons 14 and provides a suppression voltage to suppress secondary electrons back into the collection plate 40c. However, this embodiment does not contain a length of significant longitudinal distance wherein low velocity neutralizing-background-ions 42 are formed. While there will still be neutralizing-background-ions 42 formed, many of these will be formed at relatively high velocities that can easily be lost from the system. It is hence useful to calculate the parameters required for the hole size of electrode 18f should it be desired to slow the electrons 14 down to 5 eV prior to accelerating the electrons 14 into the collection plate 40a under the assumption of no neutralization.

For the case of a 5 V electrode 18f, v=1.33×10⁶ m/s, and with I=10,000 A this leaves λ=I/v=7.54×10⁻³ C/m, and, with a beam radius of r=30 cm, this leaves a charge per unit volume of ρ=λ/πr²=2.67×10⁻² C/m³. If the spacing of the wires is 100 microns, a good estimate of the self space charge depression is given by use of Gauss's Law ∫ε₀E(dA)=qᵢₙ. (Here, ε₀=8.85×10⁻¹² C²/Nm², E is the electric field, dA is the differential area and qᵢₙ is the charge within the volume surrounded by the area of integration.) Within a sphere of charge of radius r this becomes ε₀E4πr²=(4/3)πr³ρ, or, E=(ρ/3ε₀)r, and the self potential is V=∫Edr=(ρ/6ε₀)r². With r=0.05 mm this leaves a self potential of

V=(2.67×10⁻²C/m³)(5×10⁻⁵ m)²/6(8.85×10⁻¹² C²/Nm²)=1.25 V. (11)

1.25 V is an appropriate amount of space charge voltage depression to allow a 5 V electron 14 beam to pass through the grid holes without reflecting, and hence the 100 micron hole size is appropriate in this case, although the ion trapping that will exist will allow hole sizes in the range of 100 microns to 1 mm. Since the amount of beam intercepted on the grid will be proportional to the grid wire size divided by the hole size, and since the hole size requirement is much smaller in the third preferred electron beam collector embodiment than it is for the first preferred electron beam collector embodiment, this is a relative disadvantage of this approach. The advantage is that no neutralizing-background-ions 42 are required for operation of the third preferred electron beam collector embodiment.

The advantage of the invention will allow for high efficiency collection of an electron 14 beam without relying on the formation of neutralizing-background-ions 42. This will allow for an optimization of the overall efficiency of colliding beam fusion devices.

### A Fourth Electron Beam Collector Preferred Embodiment—A Segmented Collector Employing Two Low Voltage Grids and Two Collection Plates

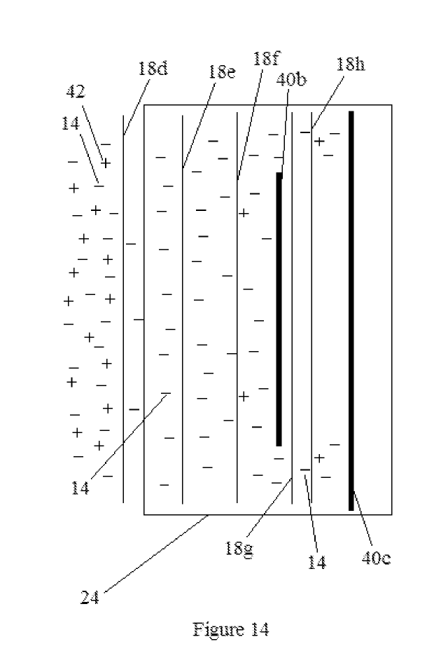

A fourth preferred electron beam collector 24 embodiment is shown in FIG. 14. In this embodiment, the electron 14 beam passes through electrode 18d (electrode 18d is also shown in FIG. 1) and then the electron 14 beam is accelerated and passes through electrode 18e. Next, the electron 14 beam is decelerated and passes through electrode 18f just before the central portion of the electron 14 beam is accelerated into a collection plate 40b. The collection plate 40b may be water cooled. The outer portion of the electron 14 beam is accelerated by electrode 18g, then decelerated by electrode 18h and finally accelerated into a collection plate 40c. Electrodes 18d, 18e, 18f, 18g and 18h can be constructed with either substantially square segments as shown in FIG. 3, substantially annular segments as shown in FIG. 5, substantially hexagonal segments as shown in FIG. 7, or a combination of those, or any substantially open segments. Electrodes 18g and 18h could optionally be constructed as shown in FIG. 11, which shows substantially square segments in an outer annular region as an example, but any substantially open segments in the outer annular region should perform well. The collection plate 40b can be constructed as a disk, and the collection plate 40c can be constructed either as a disk or as an annular structure as shown in FIG. 12.

The operation of the fourth preferred embodiment is similar to the operation of the third preferred embodiment, except that the outer portion of the electron 14 beam passes by the first collection plate 40b. For an electron cooled colliding beam fusion application, the outer portion of the electron 14 beam could have a higher energy than the central portion of the beam. In order to recover the energy, electrode 18h is biased more negatively than electrode 18f, and the collection plate 40c is biased more negatively than the collection plate 40b. As was the case in the third preferred electron beam collector 24 embodiment, the hole sizes for the electrodes 18f and 18h will be approximately 100 microns to one mm.

The advantage of the invention will allow for very high efficiency collection of an electron 14 beam that has different energy in different segments without relying on the formation of neutralizing-background-ions 42. This will allow for an optimization of the overall efficiency of colliding beam fusion devices.

### A Comment on Wire Sizes for the Electron Beam Collector Preferred Embodiments

For all of the gridded electrode 18 structures discussed in the above preferred electron beam collector embodiments that have hole sizes in the range close to 1 cm, a 10 micron wire size will intercept about 0.2% of the beam, which should make power dissipation manageable. For the cases where hole sizes of 100 microns are indicated, the wire size would optimally be in the range of 100 nanometers.

What is claimed is:

1. A segmented electron beam and particle beam system including a segmented electron beam and a particle beam, comprising:
a vacuum chamber to allow passage, merging and separation of said segmented electron beam and said particle beam including an overlap region wherein said segmented electron beam and said particle beam are overlapped;
an electron supply device including a segmented cathode including separate electron emitting segments separated from each other by a non-emitting-region to produce said segmented electron beam;
a first electrode located proximate to said segmented cathode and biased at a potential to accelerate said segmented electron beam away from said segmented cathode;
a second electrode located proximate to and downstream of said first electrode and biased at a potential less than said first electrode in order to decelerate said segmented electron beam and to provide one end of a longitudinal force for a trap for neutralizing-background-ions;
a magnetic field production device to create magnetic fields to guide said segmented electron beam along a desired path, merge and separate said segmented electron beam and said particle beam and to provide a transverse force for a trap for neutralizing-background-ions;
a third electrode located proximate to said overlap region and biased at a potential to set the velocity of said segmented electron beam to the desired velocity of said particle beam;
an electron collector including a fourth electrode, a fifth electrode, a sixth electrode and a collection plate to collect said segmented electron beam and to provide a second end of a longitudinal force for a trap for neutralizing-background-ions;

2. A system in accordance with claim 1, wherein each of said electron emitting segments of said segmented cathode is biased independently to control the velocity and current of a corresponding segment of said segmented electron beam.

3. A system in accordance with claim 1, wherein each of said electron emitting segments of said segmented cathode is heated independently to control the current of a corresponding segment of said segmented electron beam.

4. A system in accordance with claim 1, wherein each of said electron emitting segments of said segmented cathode is independently fabricated with materials to limit the current of a corresponding segment of said segmented electron beam.

5. A system in accordance with claim 1, wherein each of said first electrode, said second electrode, said third electrode, said forth electrode, said fifth electrode and said sixth electrode contain a substantially central opening to allow passage of said segmented electron beam.

6. A system in accordance with claim 1, wherein each of said first electrode and said second electrode have their substantially central openings aligned with said electron emitting segments of said segmented cathode to allow passage of said segmented electron beam without intercepting substantial amounts of said segmented electron beam on their non-open structures.

7. A method of cooling a particle beam with a segmented electron beam comprising the steps of:
operating a vacuum chamber to allow passage, merging and separation of said segmented electron beam and said particle beam including an overlap region wherein said segmented electron beam and said particle beam are overlapped;
operating an electron supply device including a segmented cathode comprised of separate electron emitting segments separated from each other by a non-emitting-region to produce said segmented electron beam;
operating a first electrode located proximate to said segmented cathode and biased at a potential to accelerate said segmented electron beam away from said segmented cathode;
operating a second electrode located proximate to and downstream of said first electrode and biased at a potential less than said first electrode in order to decelerate said segmented electron beam and to provide one end of a longitudinal force for a trap for neutralizing-background-ions;
operating a magnetic field production device to create magnetic fields to guide said segmented electron beam along a desired path, merge and separate said segmented electron beam and said particle beam and to provide a transverse force for a trap for neutralizing-background-ions;
operating a third electrode located proximate to said overlap region and biased at a potential to set the velocity of said segmented electron beam to the desired velocity of said particle beam;
operating an electron collector including a fourth electrode, a fifth electrode, a sixth electrode and a collection plate to collect said segmented electron beam and to provide a second end of a longitudinal force for a trap for neutralizing-background-ions;

8. A method in accordance with claim 7, wherein each of said electron emitting segments of said segmented cathode is biased independently to control the velocity and current of a corresponding segment of said segmented electron beam.

9. A method in accordance with claim 7, wherein each of said electron emitting segments of said segmented cathode is heated independently to control the current of a corresponding segment of said segmented electron beam.

10. A method in accordance with claim 7, wherein each of said electron emitting segments of said segmented cathode is independently fabricated with materials to limit the current of a corresponding segment of said segmented electron beam.

11. A method in accordance with claim 7, wherein each of said first electrode, said second electrode, said third electrode, said forth electrode, said fifth electrode and said sixth electrode contain a substantially central opening to allow passage of said segmented electron beam.

12. A method in accordance with claim 7, wherein each of said first electrode and said second electrode have their substantially central openings aligned with said electron emitting segments of said segmented cathode to allow passage of said segmented electron beam without intercepting substantial amounts of said segmented electron beam on their non-open structures.

13. An electron beam and electron collector system including an electron beam and an electron collector, comprising:
a vacuum chamber to allow passage of said electron beam and to maintain low pressure;
a first electrode located at the upstream end of said electron collector to allow passage of said electron beam;
a second electrode located downstream from said first electrode and biased negatively with respect to said first electrode to allow passage of said electron beam and to decelerate said electron beam;
a collection plate located downstream from said second electrode and biased positively with respect to said second electrode to collect the electron beam;
a magnetic field production device to provide a transverse force for a trap for neutralizing-background-ions;

14. A system in accordance with claim 13, wherein said first electrode includes a grid conducting structure to allow passage of said electron beam.

15. A system in accordance with claim 13, wherein said second electrode includes a grid conducting structure to allow passage of said electron beam.

16. A system in accordance with claim 13, wherein said second electrode includes two grid conducting structures at the ends of an outer conducting shell structure to allow passage of said electron beam and to contain neutralizing-background-ions.

17. A system in accordance with claim 13, wherein said magnetic field production device includes solenoidal and torroidal wire windings with electric current flowing through the wires

18. A system in accordance with claim 13, wherein said magnetic field production device includes solenoidal and torroidal wire windings with electric current flowing through the wires and permanent magnet material.

19. A method of collecting an electron beam in an electron collector, comprising the steps of:
operating a vacuum chamber to allow passage of said electron beam and to maintain low pressure;
operating a first electrode located at the upstream end of said electron collector to allow passage of said electron beam;
operating a second electrode located downstream from said first electrode and biased negatively with respect to said first electrode to allow passage of said electron beam and to decelerate said electron beam;
operating a collection plate located downstream from said second electrode and biased positively with respect to said second electrode to collect the electron beam;
operating a magnetic field production device to provide a transverse force for a trap for neutralizing-background-ions;

20. A method in accordance with claim 19, wherein said first electrode includes a grid conducting structure to allow passage of said electron beam.

21. A method in accordance with claim 19, wherein said second electrode includes a grid conducting structure to allow passage of said electron beam.

22. A method in accordance with claim 19, wherein said second electrode includes two grid conducting structures at the ends of an outer conducting shell structure to allow passage of said electron beam and to contain neutralizing-background-ions.

23. A method in accordance with claim 19, wherein said magnetic field production device includes solenoidal and torroidal wire windings with electric current flowing through the wires.

24. A method in accordance with claim 19, wherein said magnetic field production device includes solenoidal and torroidal wire windings with electric current flowing through the wires and permanent magnet material.

25. An electron beam and electron collector system including an electron beam and an electron collector, comprising:
a vacuum chamber to allow passage of said electron beam and to maintain low pressure;
a first electrode located at the upstream end of said electron collector to allow passage of said electron beam;
a second electrode located downstream from said first electrode and biased negatively with respect to said first electrode to decelerate said electron beam;
a first collection plate located downstream from said second electrode and biased positively with respect to said second electrode to collect the substantially central portion of said electron beam;
a third electrode located proximate to said first collection plate to allow passage of said electron beam;
a fourth electrode located downstream from said third electrode and biased negatively with respect to said third electrode to decelerate said electron beam;
a second collection plate located downstream from said fourth electrode and biased positively with respect to said fourth electrode to collect the substantially outer portion of said electron beam;
a magnetic field production device to provide a transverse force for a trap for neutralizing-background-ions;

26. A system in accordance with claim 25, wherein said first electrode and said third electrode include a grid conducting structure to allow passage of said electron beam.

27. A system in accordance with claim 25, wherein at least one of said second electrode and said fourth electrode include a grid conducting structure to allow passage of said electron beam.

28. A system in accordance with claim 25, wherein at least one of said second electrode and said fourth electrode include two grid conducting structures at the ends of an outer conducting shell structure to allow passage of said electron beam and to contain neutralizing-background-ions.

29. A system in accordance with claim 25, wherein said magnetic field production device includes solenoidal and torroidal wire windings with electric current flowing through the wires.

30. A system in accordance with claim 25, wherein said magnetic field production device includes solenoidal and torroidal wire windings with electric current flowing through the wires and permanent magnet material.

31. A method of collecting an electron beam in an electron collector, comprising the steps of:
operating a vacuum chamber to allow passage of said electron beam and to maintain low pressure;
operating a first electrode located at the upstream end of said electron collector to allow passage of said electron beam;
operating a second electrode located downstream from said first electrode and biased negatively with respect to said first electrode to decelerate said electron beam;
operating a first collection plate located downstream from said second electrode and biased positively with respect to said second electrode to collect the substantially central portion of said electron beam;
operating a third electrode located proximate to said first collection plate to allow passage of said electron beam;
operating a fourth electrode located downstream from said third electrode and biased negatively with respect to said third electrode to decelerate said electron beam;
operating a second collection plate located downstream from said fourth electrode and biased positively with respect to said fourth electrode to collect the substantially outer portion of said electron beam;
operating a magnetic field production device to provide a transverse force for a trap for neutralizing-background-ions;

32. A method in accordance with claim 31, wherein said first electrode and said third electrode include a grid conducting structure to allow passage of said electron beam.

33. A method in accordance with claim 31, wherein at least one of said second electrode and said fourth electrode include a grid conducting structure to allow passage of said electron beam.

34. A method in accordance with claim 31, wherein at least one of said second electrode and said fourth electrode include two grid conducting structures at the ends of an outer conducting shell structure to allow passage of said electron beam and to contain neutralizing-background-ions.

35. A method in accordance with claim 31, wherein said magnetic field production device includes solenoidal and torroidal wire windings with electric current flowing through the wires.

36. A method in accordance with claim 31, wherein said magnetic field production device includes solenoidal and torroidal wire windings with electric current flowing through the wires and permanent magnet material.
